(19) United States
(12) Patent Application Publication
(10) Pub. No.: US 2009/0094368 A1
(43) Pub. Date: Apr. 9, 2009

(54) INSTANT MESSAGING GENERAL QUEUE DEPTH MANAGEMENT

(76) Inventors: Steven Francis Best, Georgetown, TX (US); Robert James Eggers, JR., Austin, TX (US); Janice Marie Girouard, Austin, TX (US); Jon Alan Grimm, Round Rock, TX (US)

Correspondence Address: IBM CORP (YA);C/O YEE & ASSOCIATES PC, P.O. BOX 802333, DALLAS, TX, 75380, US

(21) Appl. No.: 11/868,626

(22) Filed: Oct. 8, 2007

(51) Int. Cl. G06F 15/16

(52) U.S. Cl. 709/228

(57) ABSTRACT

The present invention provides systems, methods and computer program product code for data processing systems to manage instant messaging sessions and windows of a first user. An instant messaging chat window is initiated. Responsive to initiating the first instant messaging chat window, the first instant messaging chat window is flagged as a first active window, and an active window counter is incremented. A state of the first user is identified based on the active window counter. The state of the first user is then displayed to a second user.

### BACKGROUND OF THE INVENTION

1. Field of the Invention

The present invention relates generally to systems, methods and computer program product code for data processing systems. More specifically, the present invention relates to systems, methods, and computer program product code for updating Internet Protocol and media access control addresses within an address resolution protocol table.

2. Description of the Related Art

Instant messaging is an online chat medium, allowing users to communicate with each other and collaborate in real-time over a network data processing system. Instant messaging is commonly used over the Internet. Instant messaging applications monitor and report the status of users that have established each other as online contacts. This information is typically presented to a user in a window. Instant messaging applications are also often used by users conducting business. By utilizing instant messaging, business users can view each other's availability and initiate a text conversation with colleagues or customers when a desired contact becomes available.

Typically, with instant messaging applications, communications between users are initiated by users selecting the name of the person with which they desire to communicate. Then, the users type messages in a dialog box in the window and press “send”. These messages appear “instantly” on the selected recipient's computer.

Until now, instant messaging has been developed largely for home users, but used by home and business users alike. Instant messaging allows an organization to deploy and utilize this “need-to-have” technology in a business setting.

### SUMMARY OF THE INVENTION

The present invention provides systems, methods and computer program product code for data processing systems to manage instant messaging sessions and windows of a first user. An instant messaging chat window is initiated. Responsive to initiating the first instant messaging chat window, the first instant messaging chat window is flagged as a first active window, and an active window counter is incremented. A state of the first user is identified based on the active window counter. The state of the first user is then displayed to a second user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system is shown in which illustrative embodiments may be implemented;

FIG. 3 is a diagram illustrating components used in an instant messaging system depicted in accordance with illustrative embodiments;

FIG. 4 is a block diagram illustrating components used in an instant messaging system depicted in accordance with illustrative embodiments;

FIG. 5 is a block diagram illustrating components used in an instant messaging system depicted in accordance with illustrative embodiments;

FIG. 6 is a flow chart shown illustrating an instant messaging application executing on a client in accordance with illustrative embodiments;

FIG. 7 is a flow chart illustrating an instant messaging application executing on a server in accordance with illustrative embodiments;

FIG. 8 is a flow chart depicting the process for tracking the number of active chat windows in a client system in accordance with illustrative embodiments; and

FIG. 9 is a flow chart depicting the process for updating clients in a contact list with a number of active chat windows operated by a client in accordance with illustrative embodiments.

### DETAILED DESCRIPTION OF THE PREFERRED EMBODIMENT

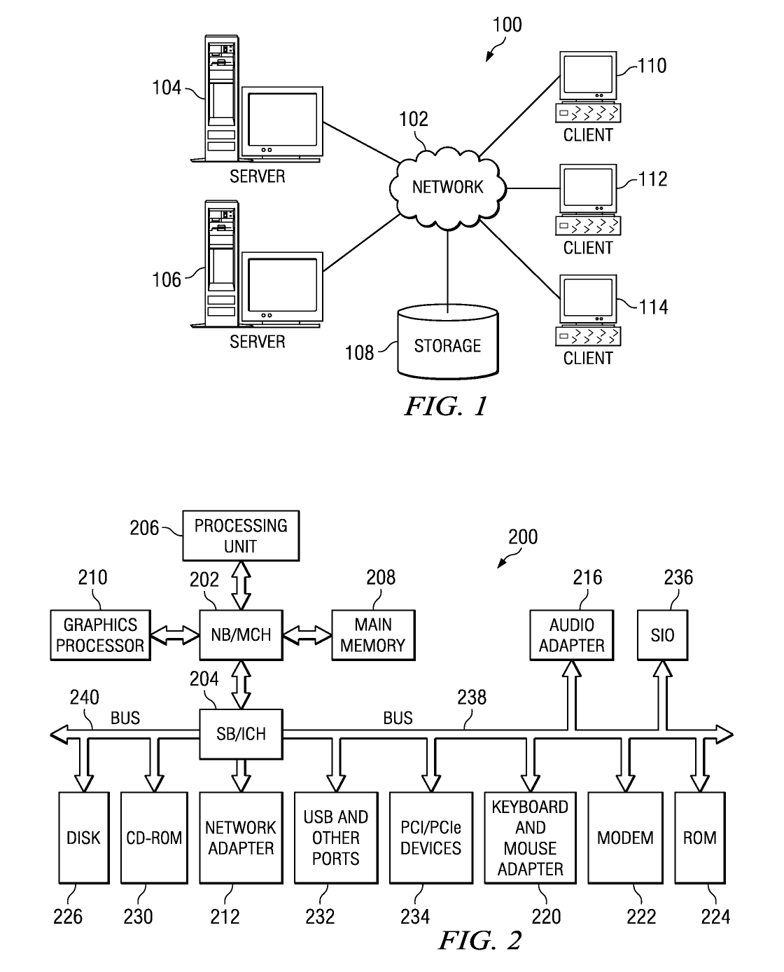

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Instant messaging is an online chat medium, allowing users to communicate with each other and collaborate in real-time over a network data processing system. Instant messaging is commonly used over the Internet. Instant messaging applications monitor and report the status of users that have established each other as online contacts. Typically, with instant messaging applications, communications between users are initiated by users selecting the name of the person with which they desire to communicate. Then, the users type messages in a dialog box in the window and press “send”. These messages appear instantly on the selected recipient's computer.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide systems, methods, and computer program product code to manage instant messaging sessions and windows of a first user. An instant messaging chat window is initiated. Responsive to initiating the first instant messaging chat window, the first instant messaging chat window is flagged as a first active window, and an active window counter is incremented. A state of the first user is identified based on the active window counter. The state of the first user is then displayed to a second user.

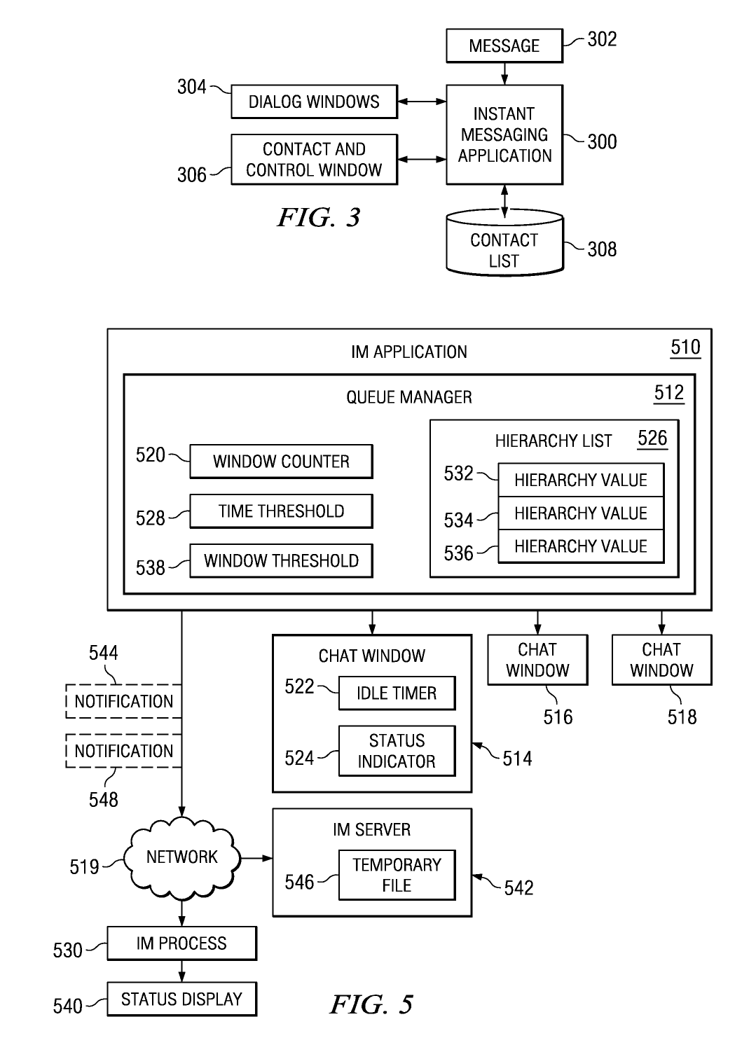

Turning next to FIG. 3, a diagram illustrating components used in an instant messaging system are depicted in accordance with illustrative embodiments.

In the depicted example, instant messaging application 300 processes messages, such as message 302 received from users located on remote data processing systems. As messages are received, these messages are presented in dialog windows 304. Messages exchanged between instant messaging application 300 and an instant messaging application on a remote data processing system form a conversation in these examples.

Additionally, dialog windows 304 provide an interface for user input to send messages to other users. Contact and control window 306 is presented by instant messaging application 300 to provide the user with a list of user names, as well as other information, such as, for example, identifying other users that are currently online. Contact and control window 306 also provides an interface to allow the user to set different preferences. For example, the user may set passwords required to access different names used in instant messaging sessions. Further, a user may employ contact and control window 306 to set other preferences, such as colors and fonts used in instant messaging application 300.

Further, the list of names presented by contact and control window 306 is stored in contact list 308 in these examples. Additional user names may be added or deleted from contact list 308. Contact list 308 is employed in presenting the list of names within contact and control window 306. Additionally, the user may view the status of other users on contact and control window 306. This status may be, for example, available or busy. When the status is available, instant messaging application 300 will accept messages from another instant messaging application to start a new conversation. When the status of another user is busy, messages from instant messaging application 300 are not accepted by the other application for that user.

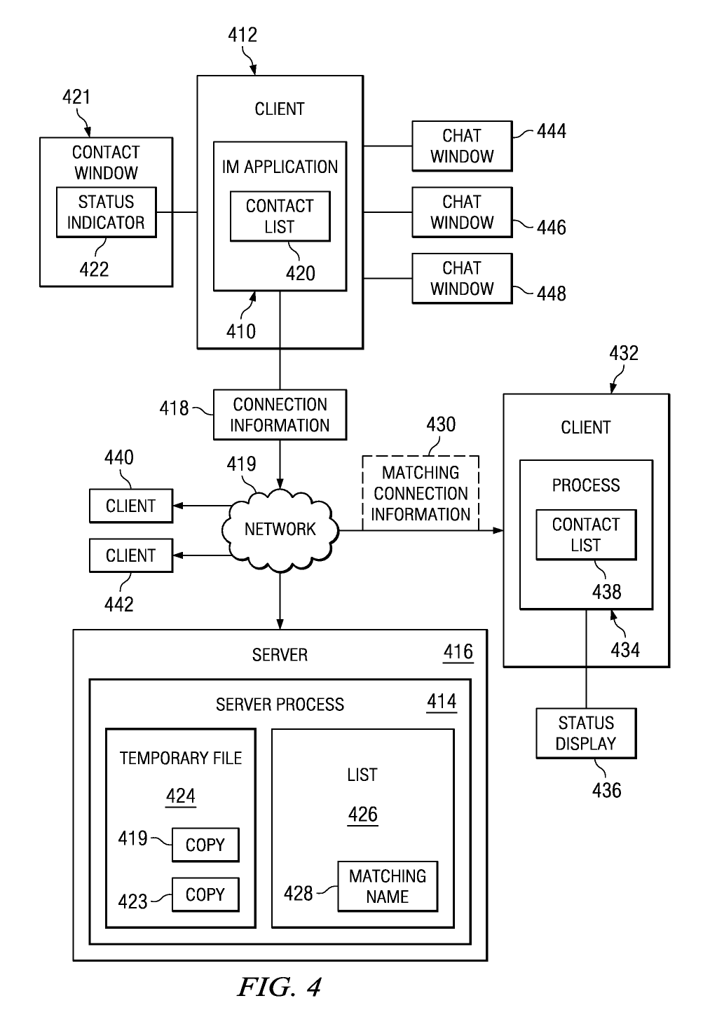

Referring now to FIG. 4, a more detailed block diagram is shown illustrating components used in an instant messaging system depicted in accordance with illustrative embodiments. Instant messaging application 410 running on client 412 sends connection information 418 through network 419 to server process 414 running on server 416. Connection information 418 includes at least a login name, the internet protocol (IP) address and a port number assigned to instant messaging application 410 of the client 412.

Instant messaging application 410 also provides server process 414 with the names of those people listed in client's contact list 420. Instant messaging application 410 also displays contact window 421, showing a graphical display of contact list 420. Login name and status indicator 422 is displayed for each person listed in client's contact list 420. As persons listed in the client's contact list 420 log into server 416, status indicator 422 is switched from “offline” to “online,” showing that client 412 is connected to, and logged into, server 416.

Server process 414 creates temporary file 424 containing copy 419 of connection information 418 and copy 423 of contact list 420. Server process 414 then determines whether any of the people listed in client's contact list 420 are currently logged in. Server process 414 accomplishes this determination by comparing list 426 of currently logged-in users with the names of those people listed in copy 423 of client's contact list 420. List 426 contains at least the login names for the currently logged-in users and connection information for each of the currently logged-in users. Alternatively, list 426 could contain a pointer that points to a temporary file containing the connection information for each of the currently logged-in users.

Upon finding matching name 428 among login names of list 426, server process 414 sends a message back to instant messaging application 410 on client 412 with matching connection information 430 for matching name 428. Server process 414 also sends also sends forwards the copy 419 of connection information 418 to client 432. Client 432 is a client in a data processing system, such as clients 110, 112, and 114 of FIG. 1, corresponding to the matching name 428. Client 432 runs process 434 similar to instant messaging application 410.

Process 434 includes status display 436. Status display 436 provides an indication to client 432 of the login status of each or any of the people listed in client 432's contact list 438. Upon receiving notification from server process 414, status display 436 updates the status of client 412 to “online,” showing that client 412 is connected to and logged into server 416.

Instant messaging application 410 stores matching connection information 430 for matching name 428. Because instant messaging application 410 now has matching connection information 430, including the IP address and port number of client 432, instant messaging application 410 can communicate directly with process 434 of client 432, without having messages first routed through server 416. Thus, as long as both client 412 and client 432 remain logged-in to server 416, server 416 does not participate in any communications between client 412 and client 432. All communication is directly between client 412 and client 432.

Client 412 initiates a communication between instant messaging application 410 and process 434 by selecting the name of client 432 from contact window 421. Client can select matching name 428 by “clicking” or otherwise indicating the selection. Responsive to selecting matching name 428 from contact window 421, instant messaging application 410 opens chat window 448. Client 412 can then enter a message into chat window 448, and send that message to client 432. Each occasion that client 412 initiates a communication with a different client, instant messaging application 410 opens a new chat window. Thus, if client 412 is communicating with clients 432, 440, and 442, instant messaging application 410 will maintain three separate chat windows: chat window 438, 444, and 446.

When client 412 exits instant messaging application 410, instant messaging application 410 sends a message to server 416 to terminate the session. Server 416 sends a message to any client, such as client 432, on client 412's contact list that is currently online to indicate that client 412 has logged off. Finally, server 416 deletes the temporary file that contained the connection information for client 412. The status 436 of client 412 is updated at client 432 to indicate that client 412 is now “offline.”

Referring now to FIG. 5, a more detailed block diagram is shown illustrating components used in an instant messaging system depicted in accordance with illustrative embodiments. Instant messaging process 510 is an instant messaging application, such as instant messaging application 410 of FIG. 4.

Instant messaging process 510 contains a queue manager 512. Queue manager 512 is a software application that executes in conjunction with instant messaging process 510 and manages multiple chat windows 514, 516, and 518. Chat windows 514, 516, and 518 can be chat windows 444, 446, and 448 of FIG. 4. Network 519 can be network 419 of FIG. 4.

Queue manager 512 contains window counter 520. Window counter 520 keeps track of the total number of open, active chat windows 514, 516, and 518. Each time that instant messaging process 510 opens a new chat window, such as chat windows 514, 516, and 518, queue manager 512 increments window counter 520.

Referring now to chat window 514, queue manager 512 associates idle timer 522 and status indicator 524 with chat window 514. While each of chat windows 514, 516, and 518 will contain an analogous status indicator and idle timer, for simplicity purposes only chat window 514 is described.

Idle timer 522 determines the length of time between consecutive messages entered into chat window 514. Upon entering a chat message into chat window 514, idle timer 522 is reset. Idle timer then begins to periodically increment, until a subsequent message is entered into chat window 524.

Idle timer 522 continues to increment until time threshold 528 is reached. Time threshold 528 is a predetermined time period during which a chat response should be entered into chat window 514. Time threshold 528 can be a user-defined variable. Threshold time 528 can be a global variable applicable to one or more of chat windows 514, 516, and 518; conversely, time threshold 528 can be a local variable, and apply only to chat window 514. If a chat response is not entered into chat window 514 before idle timer 522 reaches time threshold 528, queue manager 512 changes the status of status indicator 524.

Initially, and upon initiating chat window 514, status indicator 524 is set to “active.” If a chat response is not entered into chat window 514 before idle timer 522 reaches time threshold 528, queue manager 512 changes the status of status indicator 524 from “active” to “idle.” Additionally, queue manager 512 decrements window counter 520. That is, window counter 514 is an indication only of those chat windows having a status indicator set to “active.” Window counter 514 does not include those open chat windows having a status indicator set to “idle.”

For each chat message that instant messaging process 510 sends, queue manager 512 appends the current value of window counter 520 to the message. Instant messaging process 530 of the receiving client 531 can therefore determine the state of instant messaging process 510, where the state includes the total number of active chat windows instant messaging process 510 is managing.

Instant messaging process 530 of the receiving client 531 can optionally preemptively determine the number of active chat windows instant messaging process 510 is managing. Upon establishing a connection between instant messaging Process 510 and instant messaging process 530, instant messaging process 510 sends window counter 520 to instant messaging process 508. Alternatively, instant messaging process 530 could parse window counter 520 from instant messaging process 510. Instant messaging process 530 can initiate a determination of the number of active chat windows that instant messaging process 510 is managing actively through user queries, or passively by parsing the current value of window counter 520 at predefined time intervals.

Queue manager 512 contains hierarchy list 526. Hierarchy list 526 is a priority order indicator for all instant messaging clients. That is, when a new chat window, such as 514, 516, and 518, is opened, queue manager assigns a hierarchy value 532, 534, and 536 to each window. Queue manager 512 then can reorder the appearance of chat windows 514, 516, and 518, to reflect their relative hierarchy values 532, 534, and 536. This reordering can occur, for example, by bringing a window with a higher priority to the forefront of a display screen, cascading lower priority windows behind a window of higher priority, or otherwise drawing attention to the window of higher priority.

In one illustrative embodiment, Hierarchy list 526 can be saved as a permanent priority order. The permanent priority order is then applied to all chat windows as they are initiated. The permanent priority order persists until it is altered by the user or by a priority reordering algorithm.

Hierarchy values 532, 534, and 536 can be determined based on any of: 1) the relative order in which each of chat windows 514, 516, and 518 were opened; 2) predefined values established by the recipient; 3) the relative time intervals between response times among the various windows; and 4) user selection of certain windows through indication into a graphical user interface.

In an alternative illustrative embodiment, queue manager 512 is provided with a window threshold 538. Window threshold 538 is a predetermined number of chat windows, such as chat windows 514, 516, and 518 that can be open or active at any given time. Window threshold 538 can be a user-defined variable.

Instant messaging process 530 indicates the state of people listed contact list 542. The state includes status display 540. Status display 540 provides an indication to client of the login status of each or any of the people listed contact list 542. Contact list can be a contact list 438 of FIG. 4.

A user running instant messaging process 510 appears in status display 540 of the user running instant messaging Process 530. If instant messaging process 510 is not logged-in to instant messaging server 542, status display 540 will indicated that the user of instant messaging process 510 is “offline.” Instant messaging server 542 is server 416 of FIG. 4. Upon instant messaging process 510 connecting to instant messaging server 542, instant messaging process 530 will change status display 540 to indicate that the user of instant messaging process 510 is “online.”

The user of instant messaging process 510 will continue to appear “online” to any subsequent users logging into instant messaging server 542, until window counter 520 equals or exceeds window threshold 538. Once window counter 520 equals or exceeds threshold 538, instant messaging process 510 will send notification 544 to the instant messaging server 542. Responsive to receiving notification 544, instant messaging server 542 flags or otherwise identifies the temporary file 546 associated with instant messaging process 510. Once temporary file 546 is flagged, the user of instant messaging process 510 will appear offline to any user who does not have an open chat window referencing the user of instant messaging process 510.

In the event that the window counter 520 is reduced to or below window threshold 538, instant messaging process 510 will send notification 548 to instant messaging server 542. Responsive to receiving notification 548, instant messaging server 542 removes any flag from, or otherwise removes the “offline” indication from, temporary file 546 associated with instant messaging process 510. The user of instant messaging process 510 will now again appear online to each user logged into instant messaging server 542.

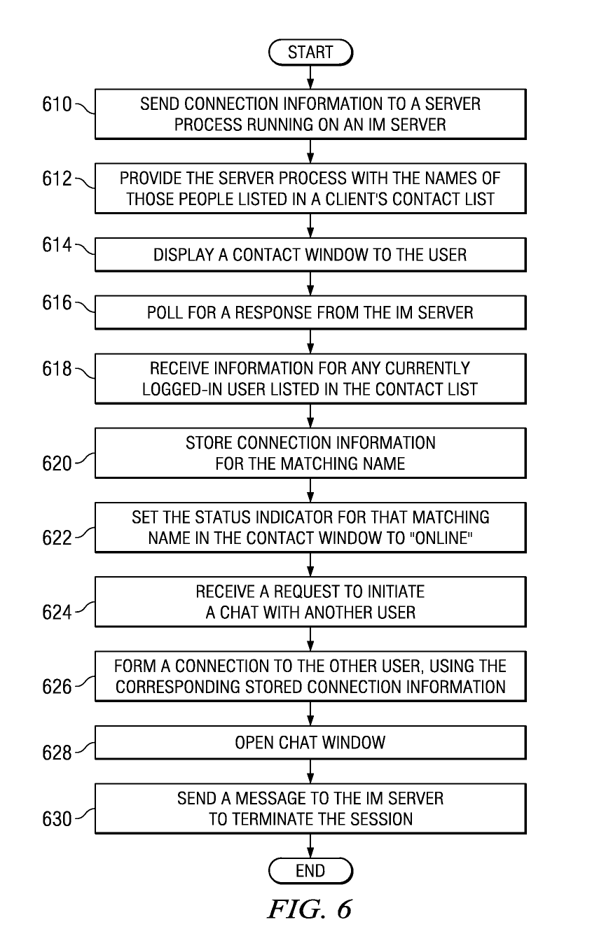

Referring now to FIG. 6, a flowchart of an instant messaging application executing on a client is depicted in accordance with illustrative embodiments. Process 600 is a software process such as instant messaging application 410 of FIG. 4, executing on a client, such as client 412 of FIG. 4.

Process 600 begins by sending connection information to a server process running on an instant messaging server (step 610). Connection information includes at least a login name, the internet protocol (IP) address and number of the port assigned to process 600. Process 600 also provides the server process with the names of those people listed in a client's contact list (step 612). Process 600 displays a contact window to the user (step 614). The contact window is a graphical display of a contact list, and includes a login name and a status indicator for each person listed in the contact list. Status indicators are initially set to “offline.” Process 600 then polls for a response from the instant messaging server (step 616).

The instant messaging server process compares a list of currently logged-in users with the names of those people listed in the contact list. Upon finding a matching name, the instant messaging server sends a message back to process 600, including connection information for each matching name.

Process 600 receives connection information from the instant messaging server for any currently logged-in user listed in the contact list (step 618). Responsive to receiving connection information, process 600 stores connection information for the matching name (step 620), and sets the status indicator for that matching name in the contact window to “online” (step 622).

Process 600 then receives a request to initiate a chat (step 624) with another user. This request can be client initiated, such as by clicking a matching name in the contact window. Alternatively, the request can be remotely initiated, such as by receiving a chat request from the other user. Responsive to receiving the request, process 600 forms a connection to the other user, using the corresponding stored connection information (step 626). Process 600 then opens chat window (step 628). Process 600 will open a new chat window for each connection to a different user. Thus, if process 600 is connected to three other users, process 600 will maintain three separate chat windows.

To terminate process 600, process 600 sends a message to the instant messaging server to terminate the session (step 630), with the process terminating thereafter. The instant messaging server sends a message to those people listed in the contact list to indicate that process 600 is logging off.

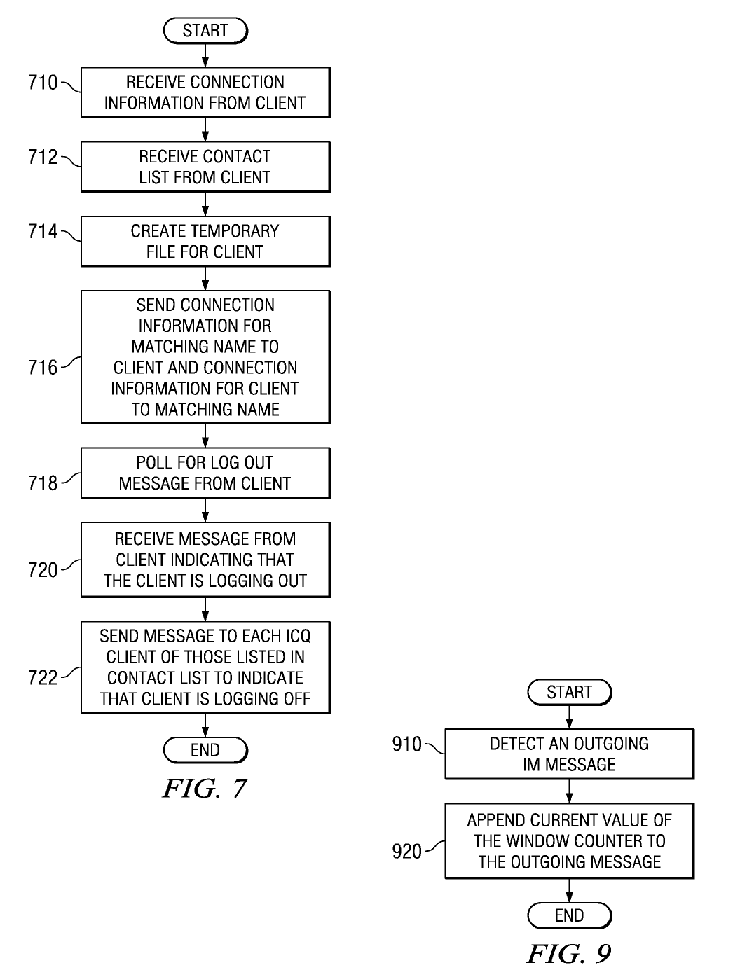

Referring now to FIG. 7, a flowchart of an instant messaging application executing on a server is depicted in accordance with illustrative embodiments. Process 700 can be server process 414 of FIG. 4.

Process 700 begins by receiving connection information from a client (step 710). Connection information includes at least a login name, the internet protocol (IP) address and a port number assigned to instant messaging application of the client. Process 700 also receives a contact list from the client (step 712).

Process 700 creates a temporary file for the client (step 714), containing the connection information and the contact list. Process 700 then determines whether any of the people listed in the contact list are currently logged into the instant messaging server by comparing a list of currently logged-in users with the names of those people in the contact list.

Upon finding a matching name between the list of currently logged-in users and the names of those people in the contact list, process 700 sends connection information for the matching name to the client, and also sends connection information for the client to the matching name (step 716). Process 700 then polls for a log out message from the client (step 718).

When the client exits instant messaging application, process 700 receives a message from the client indicating that the client is logging out (step 720). Process 700 then sends a message to each of those people listed in the contact list to indicate that process 700 is logging off (step 722). Process 700 deletes the temporary file that contained the client's connection information (step 724), and the process terminates thereafter.

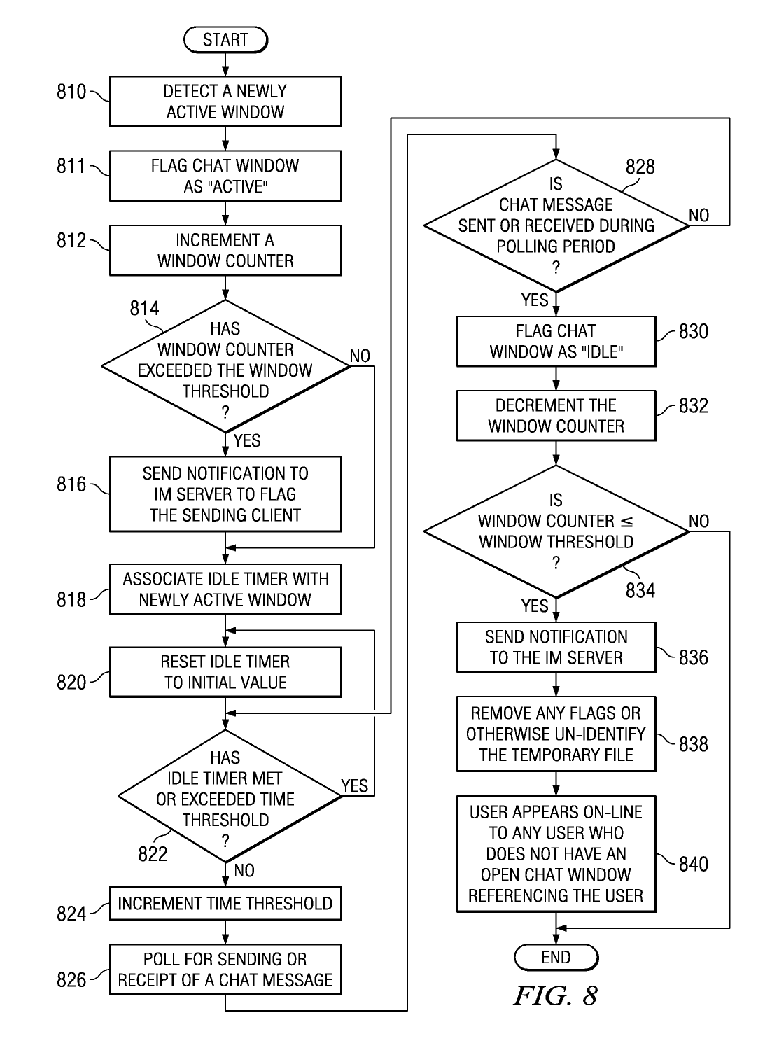

Referring now to FIG. 8, a flowchart of process for tracking the number of active chat windows in a client system is shown in accordance with illustrative embodiments. Process 800 is a software application such as queue manager 412 of FIG. 4, that executes in conjunction with an instant messaging application and manages multiple chat windows.

Process 800 begins when a newly active window is detected (step 810). A newly active window can be a newly opened chat window, or can be an inactive window which has recently become active by either sending or receiving a chat message. Process 800 flags the chat window as “active” (step 811). Responsive to identifying the chat window as “active, process 800 increments a window counter (step 812). By incrementing the window counter, process 800 is able to keep track of the total number of open, active chat windows. Each time that the instant messaging application opens a new chat window, or an idle chat window becomes active, process 800 increments window counter.

Process 800 next determines if the window counter has exceeded the window threshold (step 814). The window threshold is a predetermined number of chat windows that can be open or active at any given time. The window threshold can be a user-defined variable.

If process 800 determines that the window counter has exceeded the window threshold (“yes” at set 814), process 800 sends a notification to the instant messaging server to flag the sending client (step 816). Responsive to receiving this notification, instant messaging server flags or otherwise identifies the temporary file associated with the user of process 800. Upon identifying the temporary file, the user of process 800 will appear offline to any user who does not have an open chat window referencing the user of process 800. Process 800 then proceeds to step 818.

If process 800 determines that the window counter has not exceeded the window threshold (“no” at step 814), process 800 associates an idle timer with the newly active window (step 818). The idle timer is a window specific counter that determines the length of time between consecutive messages entered into that chat window. The idle timer will periodically increment, until a subsequent message is entered into chat window, at which point the idle timer is reset. The idle timer is reset to an initial value (step 820).

Process 800 then determines if the idle timer has met or exceeded a time threshold (step 822). The time threshold is a predetermined time period during which a chat response should be entered or received into the associated chat window. The time threshold can be a user-defined variable. The time threshold can be a global variable applicable to one or more of chat windows; conversely, the time threshold can be a local variable, and apply only to a single chat window.

If the idle timer has not met or exceeded a time threshold (“no” at step 822), process 800 increments the time threshold (step 824), and polls for the sending or receipt of a chat message (step 826). If a chat message is sent or received during the polling period (“yes” at step 828), process 800 returns to step 820. The idle timer is reset to an initial value, and process 800 begins polling for the sending or receipt of a subsequent chat message.

If a chat message is not received during the polling period (“no” at step 828), process 800 returns to step 822. Process 800 then re-determines whether idle timer has met or exceeded a time threshold.

Returning now to step 822, if the idle timer has met or exceeded the time threshold (“yes” at step 822), process 800 flags the chat window as “idle” (step 830). Responsive to identifying the chat window as “idle”, process 800 decrements the window counter (step 832).

Process 800 then again compares the decremented window counter to the window threshold to determine if the window counter is less than or equal to the window threshold (step 834). If the decremented window counter is still greater than the window threshold (“no” at step 834), the process terminates.

If the decremented window counter is now equal to or less than the window threshold (“yes” at step 834), a notification is sent to the instant messaging server (step 836). Responsive to receiving this notification, instant messaging server removes any flags or otherwise un-identifies the temporary file associated with the user of process 800 (step 838). Upon the removal of any flags associated with the user's temporary file, the user of process 800 will again appear on-line to any user who does not have an open chat window referencing the user of process 800 (step 840). Process 800 terminates thereafter.

Referring now to FIG. 9, a flowchart of a the process for updating clients in a contact list with a number of active chat windows operated by a client is shown in accordance with illustrative embodiments. Process 900 can be instant messaging application 410 of FIG. 4.

Process 900 begins by detecting an outgoing instant messaging message (step 910). Responsive to detecting an outgoing instant messaging message, process 900 appends the current value of the window counter to the outgoing message (step 920), with the process terminating thereafter. The client receiving the message can therefore determine the total number of active chat windows the sending client is managing.

Thus, the present embodiments provide systems, methods and computer program product code for data processing systems to manage instant messaging sessions and windows of a first user. An instant messaging chat window is initiated. Responsive to initiating the first instant messaging chat window, the first instant messaging chat window is flagged as a first active window, and an active window counter is incremented. A state of the first user is identified based on the active window counter. The state of the first user is then displayed to a second user.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing instant messaging sessions and windows of a first user, the method comprising:
initiating a first instant messaging chat window;
responsive to initiating the first instant messaging chat window, identifying the first instant messaging chat window as a first active window;
responsive to identifying the first instant messaging chat window as the first active window, incrementing a current count of an active window counter;
determining a state of the first user based on the active window counter; and
displaying to the state of the first user to a second user.

2. The computer implemented method of claim 1, wherein the state of the first user is the current count of the active window counter.

3. The computer implemented method of claim 1, further comprising:
providing a first time counter and a first time threshold;
periodically incrementing the first time counter;
identifying whether the first time counter has reached the first time threshold; and
responsive to identifying that the first time counter has reached the first time threshold, identifying the first active window as not an active window and decrementing the current count of the active window counter.

4. The computer implanted method of claim 3, further comprising:
identifying whether a chat response has been entered into the first active chat window; and
responsive to determining that the chat response has been entered into the first active chat window, resetting the first time counter.

5. The computer implemented method of claim 4, wherein the state of the first user is an online status of the first user, the method further comprising:
identifying whether the active window counter exceeds an active window threshold; and
responsive to identifying that the active window counter exceeds the active window threshold, identifying the online status of the first user.

6. The computer implemented method of claim 5, wherein the online status of the first user is initially set as online, and wherein identifying the online status of the first user sets the online status of the first user as offline.

7. The computer implemented method of claim 1, wherein the step of displaying the state of the first user to a second user consists of at least one of displaying the current count of the active window counter, and displaying an online status of the first user.

8. The computer implemented method of claim 1, further comprising:
initiating a second instant messaging chat window;
assigning a first hierarchy value to the first instant messaging chat window and a second hierarchy value to the second instant messaging chat window; and
displaying to the first user the first instant messaging chat window and the second instant messaging chat window, wherein the first instant messaging chat window and the second instant messaging chat window are reordered based on the first hierarchy value and the second hierarchy value.

9. The computer implemented method of claim 8, wherein the first hierarchy value and the second hierarchy value are determined based on at least one of a relative order in which the first instant messaging chat window and the second instant messaging chat window were initiated, a predefined hierarchy for the first instant messaging chat window and the second instant messaging chat window, which of the first instant messaging chat window and the second instant messaging chat window the first user has most recently entered a chat response, and selection by the first user of one of the first instant messaging chat window and the second instant messaging chat window from a graphical user interface.

10. A computer program product comprising:
a computer readable medium having computer usable program code for managing instant messaging sessions and windows for a first user, the computer program product comprising:
computer usable program code for initiating a first instant messaging chat window;
computer usable program code for, responsive to initiating the first instant messaging chat window, identifying the first instant messaging chat window as a first active window;
computer usable program code for, responsive to identifying the first instant messaging chat window as the first active window, incrementing a current count of an active window counter;
computer usable program code for determining a state of the first user based on the active window counter; and
computer usable program code for displaying the state of the first user to a second user.

11. The computer program product of claim 10, wherein the state of the first user is the current count of the active window counter.

12. The computer program product of claim 10, further comprising:
computer usable program code for providing a first time counter and a first time threshold;
computer usable program code for periodically incrementing the first time counter; computer usable program code for identifying whether the first time counter has reached the first time threshold; and
computer usable program code for, responsive to identifying that the first time counter has reached the first time threshold, identifying the first active window as not an active window and decrementing the current count of the active window counter.

13. The computer program product of claim 12, further comprising:
computer usable program code for identifying whether a chat response has been entered into the first active chat window; and
computer usable program code for, responsive to determining that the chat response has been entered into the first active chat window, resetting the first time counter.

14. The computer program product of claim 13, wherein the state of the first user is an online status of the first user, further comprising:
computer usable program code for identifying whether the active window counter exceeds an active window threshold; and
computer usable program code for, responsive to identifying that the active window counter exceeds the active window threshold, identifying the online status of the first user.

15. The computer program product of claim 14, wherein the online status of the first user is initially set as online, and wherein identifying the online status of the first user sets the online status of the first user as offline.

16. The computer program product of claim 10, wherein the computer usable program code for displaying the state of the first user to a second user consists of at least one of displaying the current count of the active window counter, and displaying an online status of the first user.

17. The computer program product of claim 10, further comprising:
computer usable program code for initiating a second instant messaging chat window;
computer usable program code for assigning a first hierarchy value to the first instant messaging chat window and a second hierarchy value to the second instant messaging chat window; and
computer usable program code for displaying to the first user the first instant messaging chat window and the second instant messaging chat window, wherein the first instant messaging chat window and the second instant messaging chat window are reordered based on the first hierarchy value and the second hierarchy value.

18. The computer program product of claim 10, wherein the first hierarchy value and the second hierarchy value are determined based on at least one of a relative order in which the first instant messaging chat window and the second instant messaging chat window were initiated, a predefined hierarchy for the first instant messaging chat window and the second instant messaging chat window, which of the first instant messaging chat window and the second instant messaging chat window the first user has most recently entered a chat response, and selection by the first user of one of the first instant messaging chat window and the second instant messaging chat window from a graphical user interface.

19. A data processing system comprising:
a bus;
a communications unit connected to the bus;
a storage device connected to the bus, wherein the storage device includes computer usable program code; and
a processor unit connected to the bus, wherein the processor unit executes the computer usable program code to initiate a first instant messaging chat window; responsive to initiating the first instant messaging chat window, identify the first instant messaging chat window as a first active window; responsive to identifying the first instant messaging chat window as the first active window, increment a current count of an active window counter; determine a state of the first user based on the active window counter wherein the state of the first user is the current count of the active window counter; provide a first time counter and a first time threshold; periodically increment the first time counter; identify whether the first time counter has reached the first time threshold; responsive to identifying that the first time counter has reached the first time threshold, identify the first active window as not an active window and decrement the current count of the active window counter; and display to the state to a second user.

20. The data processing system of claim 19, wherein the processor unit further executes the computer usable program code to initiate a second instant messaging chat window; assign a first hierarchy value to the first instant messaging chat window and a second hierarchy value to the second instant messaging chat window; and display to the first user the first instant messaging chat window and the second instant messaging chat window, wherein the the first instant messaging chat window and the second instant messaging chat window are reordered based on the first hierarchy value and the second hierarchy value.
